(19) United States
(12) Patent Application Publication
(10) Pub. No.: US 2006/0151459 A1
(43) Pub. Date: Jul. 13, 2006

(54) AIR MATTRESS WITH TEMPERATURE KEEPING DEVICE

(76) Inventor: TUN-JEN KU, TAICHUNG (TW)

Correspondence Address: LAW OFFICE OF LIAUH & ASSOC., 4224 WAIALAE AVE, STE 5-388, HONOLULU, HI, 96816, US

(21) Appl. No.: 10/905,529

(22) Filed: Jan. 7, 2005

(51) Int. Cl. H05B 1/00; H05B 3/00; H05B 11/00

(52) U.S. Cl. 219/217

(57) ABSTRACT

Provided is an air mattress comprising a casing of strong cloth foam rubber filled in the casing, an air valve provided on the casing at the other end of the mattress, and a heater comprising a heating element embedded in the foam rubber. The heater is adapted to connect to a rechargeable battery for taking current therefrom for heating and expanding the foam rubber so as to automatically draw air into the casing for inflation via the open air valve. An internal temperature of the mattress is adapted to keep at almost its original range (e.g., in the range of 45° C. to 55° C.) for a predetermined period of time after stopping heating.

### BACKGROUND OF THE INVENTION

1. Field of Invention

The present invention relates to air mattresses and more particularly to an air mattress with a heater adapted to be powered by a rechargeable battery in an outdoor environment for heating the mattress and keeping the mattress at almost its original temperature for a predetermined number of hours after stopping heating so as to bring a degree of warmness to the body sleeping thereon.

2. Related Art

Air mattresses are well known. A conventional air mattress is shown in FIG. 1. The mattress comprises a casing 1 of strong cloth fill with foam rubber 2. An air valve 3 is provided on the casing 1 at the other end of the mattress. In use, unroll the mattress and open the air valve 3. The foam rubber 2 next expands automatically due to its elasticity. Air will automatically draw into the mattress for inflation via the open air valve 3 since atmospheric pressure is larger than internal pressure of the mattress. The mattress thus inflates to its fullness. Finally, close the air valve 3. At this state, a person is able to lie on the mattress. The body temperature is supposed to be well maintained. However, this is not true as analyzed below.

Such mattress is typically used in an outdoor environment such as mountain or beach in camping. Temperature may drop sharply in the night at such environment. As such, the person sleeping on the mattress may feel cold, for example after sleeping for two or three hours. In brief, there is no provision of temperature keeping device in the mattress. Moreover, the automatic inflation function of the foam rubber 2 can be compromised in the cold environment. Thus, the need for improvement still exists.

### SUMMARY OF THE INVENTION

It is therefore an object of the present invention to provide an air mattress comprising a casing of strong cloth; foam rubber filled in the casing; an air valve provided on the casing at the other end of the mattress; and a heater comprising a heating element embedded in the foam rubber, the heater being adapted to connect to a rechargeable battery for taking current therefrom for heating and expanding the foam rubber so as to automatically draw air into the casing for inflation via the open air valve, wherein an internal temperature of the mattress is adapted to keep at almost its original range for a predetermined period of time after stopping heating.

In one aspect of the present invention, all portions of a sleeping person except the head are heated by the heater so as to fully keep warmness of the body and increase dryness on a top surface of the mattress.

In another aspect of the present invention, the heater further comprises a thermostat provided externally of the casing at one end of the mattress for regulating temperature of the heater in the range of 45° C. to 55° C.

The above and other objects, features and advantages of the present invention will become apparent from the following detailed description taken with the accompanying drawings.

### BRIEF DESCRIPTION OF THE DRAWINGS

FIG. 1 is a sectional view of a conventional air mattress with a person sleeping thereon;

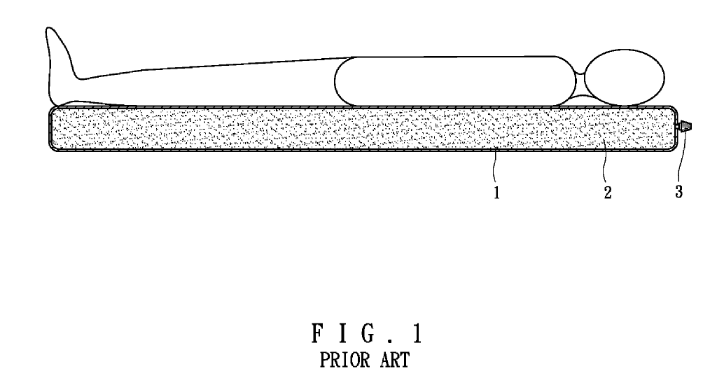

FIG. 2 is an exploded view of a preferred embodiment of air mattress according to the invention;

FIG. 3 is a perspective view of the assembled mattress of FIG. 2;

FIG. 4 is a sectional view of of the mattress of FIG. 3;

FIG. 5 is a view similar to FIG. 4, where the heater is being powered a rechargeable battery for heating the mattress;

FIG. 6 is a side sectional view of FIG. 5;

FIG. 7 is a view similar to FIG. 6, where the mattress is being inflated;

FIG. 8 is a top view of the inflated mattress of FIG. 7 with a person sleeping thereon; and

FIG. 9 is a side sectional view of FIG. 8.

### DETAILED DESCRIPTION OF THE INVENTION

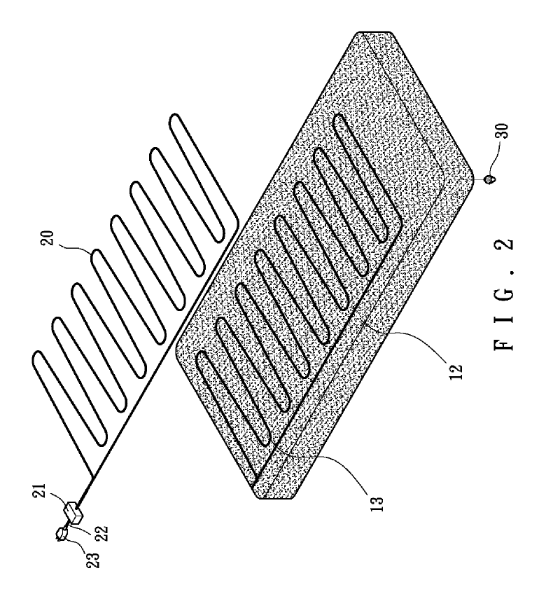

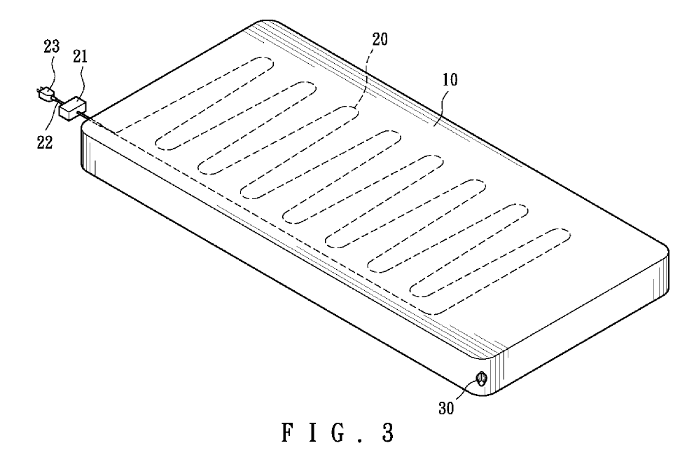

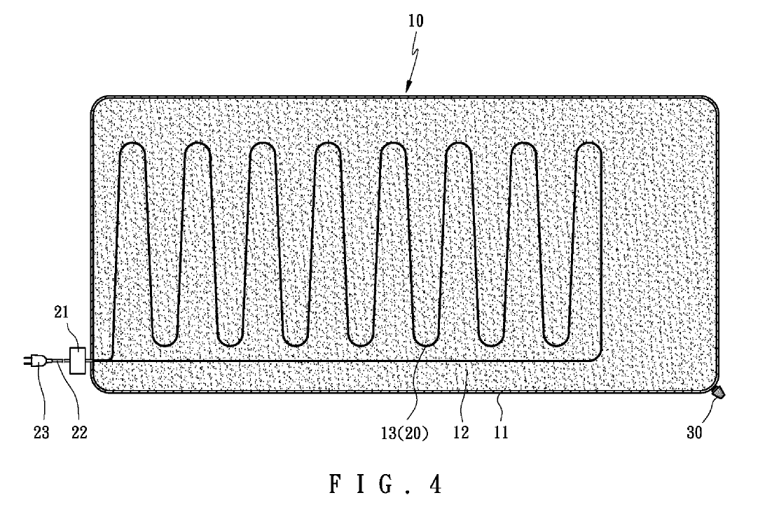

Referring to FIGS. 2, 3, and 4, there is shown an air mattress constructed in accordance with a preferred embodiment of the invention. The mattress comprises a casing 10 of strong cloth 11 fill with foam rubber 12. A continuous winding groove 13 is formed in the foam rubber 12. Area occupied by the groove 13 is about all top surface of the mattress except its head portion. A heater 20 has its heating element (e.g., electric wire) embedded in the groove 13 and comprises a thermostat 21 provided externally of one end of the mattress, the thermostat 21 adapted to regulate temperature of the heater 20 in the range of 45° C. to 55° C. A shield 22 is formed around a short section of the electric wire externally of the thermostat 21. A plug 23 is formed at an open end of the shield 22. An air valve 30 is provided on the casing 1 at the other end of the mattress.

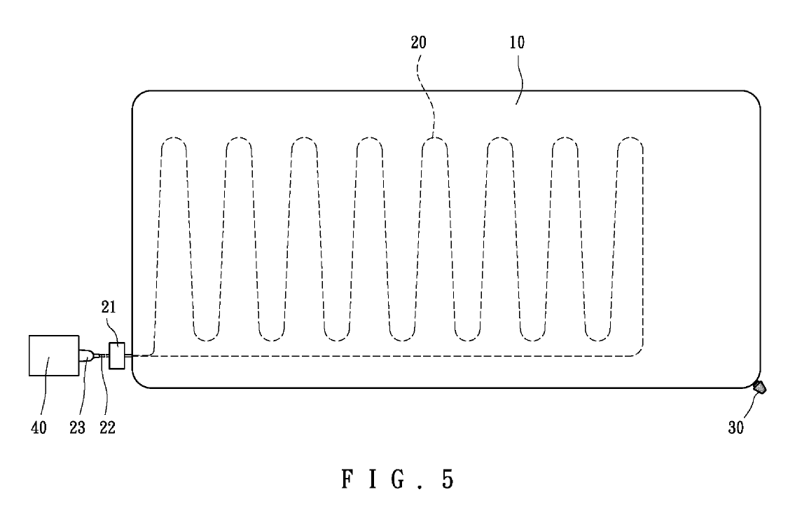

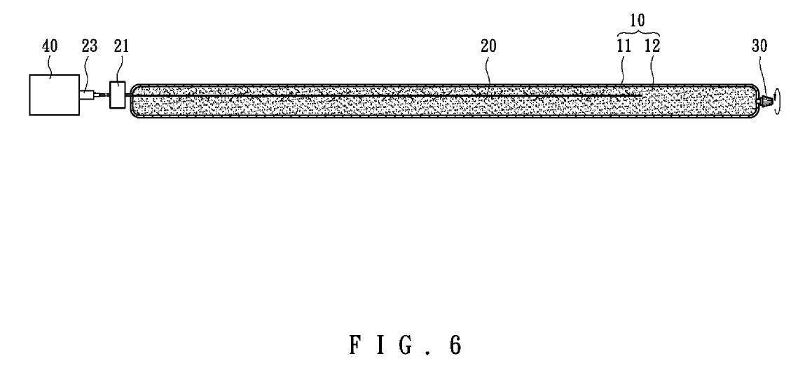

Referring to FIGS. 5 and 6, in use, for example in camping in the mountain, a person may unroll the casing 10 and open the air valve 30. However, the foam rubber 12 is unable to expand automatically due to low temperature (e.g., about 5° C. or less). In this case, the person may connect the plug 23 to a rechargeable battery 40 for taking current therefrom. As a result, the heater 20 begins to heat the mattress with its heating element.

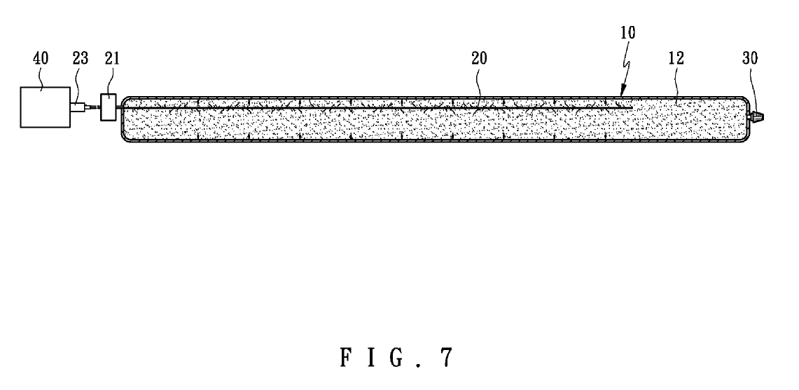

Referring to FIG. 7, the internal temperature of the mattress (i.e., the foam rubber 12) begins to rise and will be kept in the range of 45° C. to 55° C. by the thermostat 21 thereafter. As such, the foam rubber 12 is able to expand by taking advantage of its elasticity. Air will automatically, quickly draw into the mattress for inflation via the open air valve 30 since atmospheric pressure is larger than internal pressure of the casing 10. The mattress thus inflates to its fullness. Finally, disconnect the plug 23 and close the air valve 30 for keeping air-tightness of the mattress.

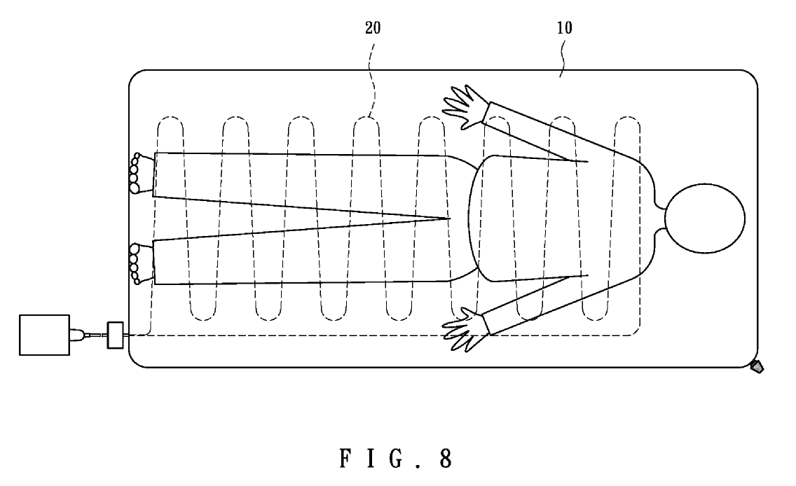

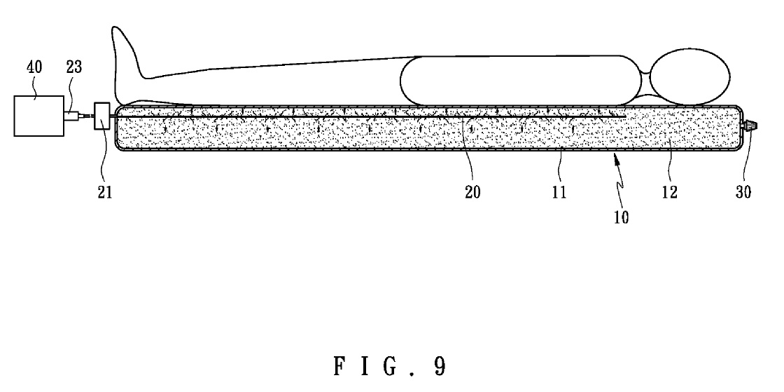

Referring to FIGS. 8 and 9, all portions of the person except the head are heated by the heater 20 when the person is sleeping on the casing 10 of the mattress. Temperature inside the casing 10 can be kept at almost the original range for, preferably eight hours due to air-tightness of the casing 10. As such, the body temperature can be well maintained while lying on the mattress. Moreover, dryness on a top surface of the mattress can be increased by the heat. This further brings a degree of comfort to the sleeping person.

While the invention herein disclosed has been described by means of specific embodiments, numerous modifications and variations could be made thereto by those skilled in the art without departing from the scope and spirit of the invention set forth in the claims.

What is claimed is:

1. An air mattress comprising:
a casing of strong cloth;
foam rubber filled in the casing;
an air valve provided on the casing at the other end of the mattress; and
a heater comprising a heating element embedded in the foam rubber, the heater being adapted to connect to a rechargeable battery for taking current therefrom for heating and expanding the foam rubber so as to automatically draw air into the casing for inflation via the open air valve,
wherein an internal temperature of the mattress is adapted to keep at almost its original range for a predetermined period of time after stopping heating.

2. The air mattress of claim 1, further comprising a continuous winding groove formed in the foam rubber for tightly receiving the heating element.

3. The air mattress of claim 1, wherein the heating element is an electric wire.

4. The air mattress of claim 3, further comprising a shield formed around a short section of the electric wire externally of the casing at one end of the mattress, and a plug formed at an open end of the shield.

5. The air mattress of claim 1, wherein the heater further comprises a thermostat provided externally of the casing at one end of the mattress.

6. The air mattress of claim 5, wherein the thermostat is adapted to regulate temperature of the heater in the range of 45° C. to 55° C.
